(19) United States
(12) Patent Application Publication
(10) Pub. No.: US 2002/0064085 A1
(43) Pub. Date: May 30, 2002

(54) Garbage processing machine

(76) Inventors: Kenzo Takahashi, Kamifukuoka-shi (JP); Masaya Takahashi, Tsuruokashi (JP)

Correspondence Address: McCormick, Paulding & Huber, City Place II, 185 Asylum Street, Hartford, CT, 06103-3402, US

(21) Appl. No.: 09/997,505

(22) Filed: Nov. 20, 2001

(30) Foreign Application Priority Data
Nov. 28, 2000 (JP) 2000-361138
Nov. 28, 2000 (JP) 2000-361139

(51) Int. Cl. B01F 15/06

(52) U.S. Cl. 366/144; 141/203

(57) ABSTRACT

A garbage processing machine, wherein both an air supply line, which supplies high-temperature air for drying and air for cooling, and an exhaust gas line, which exhausts the air, are connected to a heating mixer, which dry-processes garbage with mixing, and also wherein the garbage processing machine is comprising a deodorizing apparatus, which is provided in an exhausted gas line and deodorizes exhausted gas at high temperature, and comprising a heater, which is provided in the air supply line and heats air by exhausted heat that is exhausted from the deodorizing apparatus. By this garbage processing machine, garbage can be effectively dry-processed and can be effectively used as feeds of domestic animals or as such. Moreover, by providing a deodorizer, emission of odor at the time of dry processing is prevented and deterioration of the local environments is also prevented.

### CROSS REFERENCES TO RELATED APPLICATIONS

This application claims priority of Japanese Patent Application No. 2000-361138 and No. 2000-361139 filed in JPO together on Nov. 28, 2000, the entire disclosures of which are incorporated herein by reference.

### BACKGROUND OF THE INVENTION

1. Field of the Invention

The present invention relates to a garbage processing machine.

2. Description of the Related Art

Conventionally, most of the garbage exhausted from food plants, markets, restaurants or usual families are sent to incineration facilities for being incinerated as combustible garbage or are buried under ground for being decomposed by microorganisms for the time being. However the total amount of annually abandoned garbage has been continuously increasing year by year, resulting in one of the main cause for deterioration of the financial condition of local governments, who have responsibilities for the processing of the garbage.

Moreover, damages are reported that these kinds of garbage often deteriorates the local environments by putrid smell of the garbage, or that these kinds of garbage are eaten away and are scattered around by small animals such as crows or cats at garbage pits before the garbage are collected, especially in the summer season, since these kinds of garbage are assembled together at garbage pits on predetermined dates.

### SUMMARY OF THE INVENTION

The object of the present invention is to provide a novel garbage processing machine, which can process garbage effectively, and in which processed garbage can be reused effectively.

Moreover, another object of the present invention is to provide a novel garbage processing machine, which can process garbage effectively and also which does not deteriorate the local environments when processed garbage can be reused effectively.

The further object of the present invention is to provide a novel garbage processing machine, which can process garbage effectively and also which has an excellent energy efficiency in effectively reusing the processed garbage.

According to one aspect of the present invention, there is provided a garbage processing machine, wherein both an air supply line, which supplies high-temperature air for drying and air for cooling, and an exhaust gas line, which exhausts the air, are connected to a heating mixer, which dry-processes garbage with mixing, and also wherein the garbage processing machine is comprising a deodorizing apparatus, which is provided in an exhausted gas line and deodorizes exhausted gas at high temperature, and comprising a heater, which is provided in the air supply line and heats air by exhausted heat that is exhausted from the deodorizing apparatus.

### BRIEF DESCRIPTION OF THE DRAWINGS

FIG. 1 is a whole scheme diagram, which shows an embodiment of raw garbage machine.

FIG. 2 is a cross-sectional view, which shows an embodiment of a heating mixer that is used in the garbage processing machine.

FIG. 3 is a cross-sectional view taken along the line A-A in FIG. 2.

FIG. 4 is a cross-sectional view, which shows an embodiment of a heating mixer used in the garbage processing machine.

FIG. 5 is a sequence diagram, which shows an example of an operating method of the garbage processing machine.

FIG. 6 is a diagram, which shows another embodiment of a heating mixer used in the garbage processing machine.

FIG. 7 is a diagram, which shows another embodiment of the deodorizing apparatus used in the garbage processing machine.

### DETAILED DESCRIPTION OF THE PREFERRED EMBODIMENTS

A preferable embodiment of the present invention will now be described in reference to the accompanying drawings.

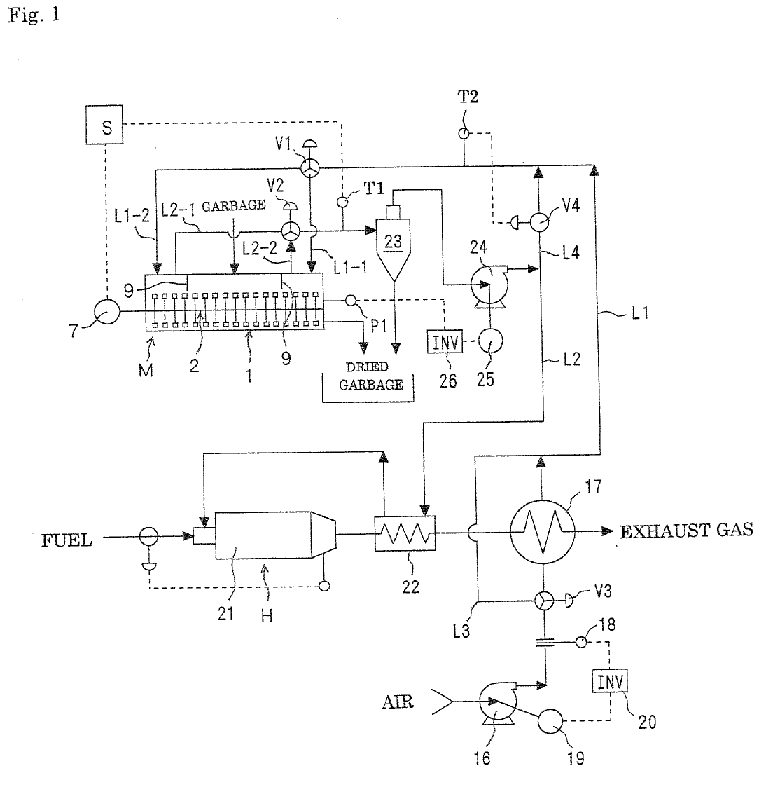

FIG. 1 shows an embodiment of garbage processing machine of the present invention.

As shown in FIG. 1, this garbage processing machine has a structure that both the air supply line L1, which supplies high-temperature air for drying and air for cooling, and the exhausted gas line L2, which exhausts the air, are connected to the heating mixer M that dry-processes garbage with mixing, and also the deodorizing apparatus H that deodorizes the exhausted gas at high temperature is provided in the exhausted gas line L2.

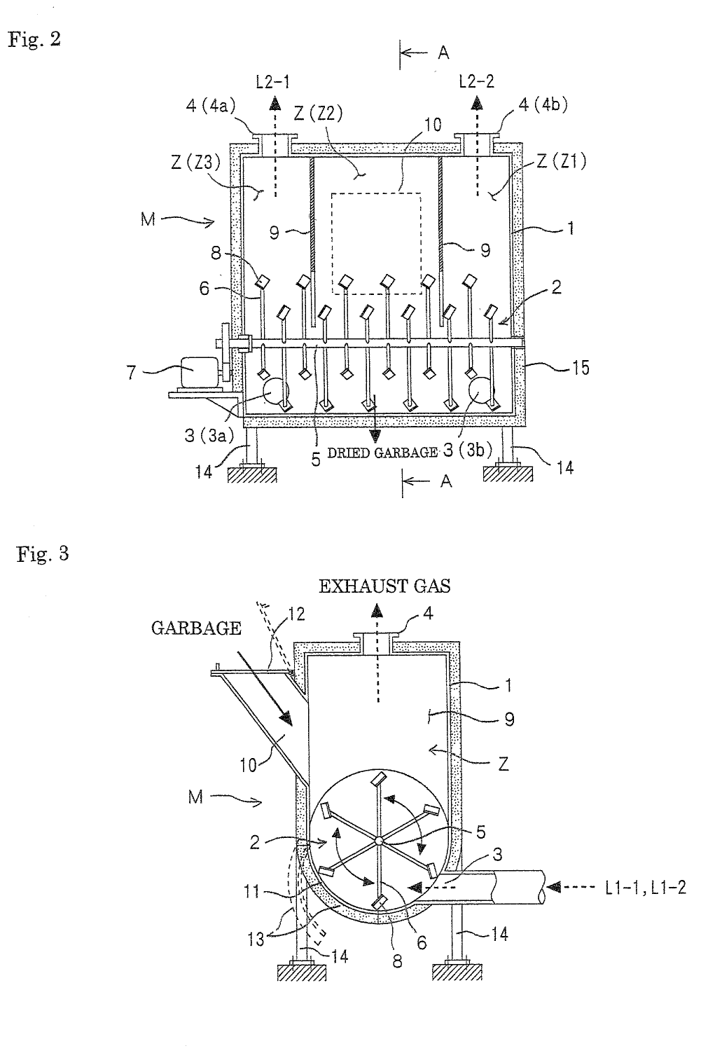

At first, as shown in FIGS. 2 and 3, a heating mixer M is composed that the air entrance 3, into which high-temperature air for drying and air for cooling is provided and the air exit 4, from which supplied air exhausted, is formed in addition that the mixing mechanism 2 is provided in the casing 1 with a generally rectangular shape including bottom part with a semi-cylindrical shape.

This mixing mechanism 2 is composed that a plural of rotating impellers 6, 6 . . . are axially provided along the longitudinal direction of and around the rotating axis 5 located in the same axis as that of the inner bottom portion of the casing 1 with a semi-cylindrical shape, and that garbage that is thrown into the casing 1 is combed up to the upper part of the casing 1 and is mixed by rotationally actuated the rotating axis 5 by the motor 7.

Moreover, the mixing impellers 6 are provided, each of into which ends the mixing tip 8 that obliquely inclines in the rotational direction and in the longitudinal direction along the rotating axis 5 is integrally provided, respectively, so that the impellers comb up the garbage in the bottom of the casing 1 into the obliquely axial direction. That is, by providing the mixing tip 8 that incline obliquely like this, the impeller not only axially combs garbage up and mixes them, but also the impeller displays the effect in which garbage are gradually transported into one direction at the same time of mixing.

On the one hand, the air entrances 3 (3a, 3b) are respectively formed at one of both ends of the bottom of the casing 1 with a semi-cylindrical shape, respectively (3a, 3b), and the two divided lines L1-1 and L1-2 are connected to the air entrances 3 (3a, 3b), respectively, via valve V1, high-temperature air for drying or air for cooling that are sent from the air supply line L1 are supplied from bottom corners of the casing 1 into the inside of the casing 1, as shown in FIG. 1.

On the other hand, the air exits 4 (4a, 4b) are equally and respectively provided at one of both edges of the top of the casing 1 with a box shape, as shown in FIGS. 2 and 3, and have function to exhaust air that is supplied from the air entrance 3 into the casing 1, from edge parts of the top of the casing 1 into divided exhaust gas lines L2-1 and L2-2, respectively, as shown in FIG. 1.

Moreover, on the mixing mechanism 2 in the casing 1, the upper space Z for separating garbage from exhaust gas, and the upper space Z is divided by a pair of baffle plates 9, 9 into 3 spaces (Z1, Z2, Z3) along the longitudinal direction of the rotating axis 5.

Further, in the casing 1, the opening 10 for throwing garbage into and the exit 11 for excluding dry garbage after processing, so that dry garbage can be taken out from the bottom part of vibrating mechanism 2 in addition that garbage can be thrown into the side of the mixing mechanism 2 from the upper space Z2. Moreover, the opening cover 12 and the exit cover 13 are provided on the opening 10 and on the exit 11, respectively, so that the inside of casing 1 is tightly closed by shutting the opening 10 and the exit 11 during operation.

Then, in FIGS. 2 and 3, reference number 14, 14 . . . show supporting legs for putting the garbage processing machine up and supporting it on a concrete block, base body or as such, a reference number 15 shows a thermal insulation layer to prevent heat dispersion from the casing 1.

And, the heating mixer M with this kind of structure is composed that garbage that is put into the heating mixer M can be efficiently dry-processed and be cooling-processed by an operation showed in the following. That is, as the garbage that is put into the casing 1 is mixed by mixing mechanism 2, any one of the air entrance 3 or the air exit 4 is made to open or to be shut and the other one is made to be shut or to open, for example, as well as the air entrance 3b is made to open, the air exit 4b in the nearby side of the air entrance 3b is made to be shut. Then, high-temperature (ca. 200° C.) air for drying that is flowed in from the air entrance 3b, at first, directly contacts the nearby garbage that is being mixed just after the high-temperature air was flowed in, and dries the garbage by heating it, and then, the high-temperature air is, as it is, apt to flow into the side of the upper space Z1 that is directly above the mixing place, however, in addition that the high-temperature air can not be exhausted since the air exit 4b in the side of the upper space Z1 is in the state of being closed, the air can not directly flow into the side of the other air exit 4a by by-passing the upper space Z since this upper space Z1 is divided by baffle plates 9.

For this reason, air for drying that is flowed in from the air entrance 3b flows as it is along the rotating axis 5 in the mixing mechanism 2, in which garbage is being mixed, resulting in flowing of the air to be exhausted from the air exit 4a after the air passes through the upper space Z3 as it is. Moreover, when an air for cooling that is dry-processed is made to flow in from the air entrance 3b, the air flows just like this.

Therefore, since in this heating mixer M, air for drying and air for cooling is made to flow through the garbage or the dry garbage that is being constantly mixed, the air can contact the garbage (dry garbage) surely and for a long period of time, therefore, drying and cooling process can be efficiently performed.

On one hand, if air for drying that is flowed in due to the dry-processing of garbage in this way is always made to flow only in one direction, the garbage is made to put aside only to the upstream side, resulting in inhomogeneity of the dry-processing of the garbage. For this reason, after a predetermined time is passed, the open/shut state of the air entrance 3 and the air exit 4 is changed and heating (cooling) unevenness vanishes by passing air from the side of the air entrance 3a into the side of the air exit 4b, resulting in performing a homogeneous and more efficient drying and cooling process.

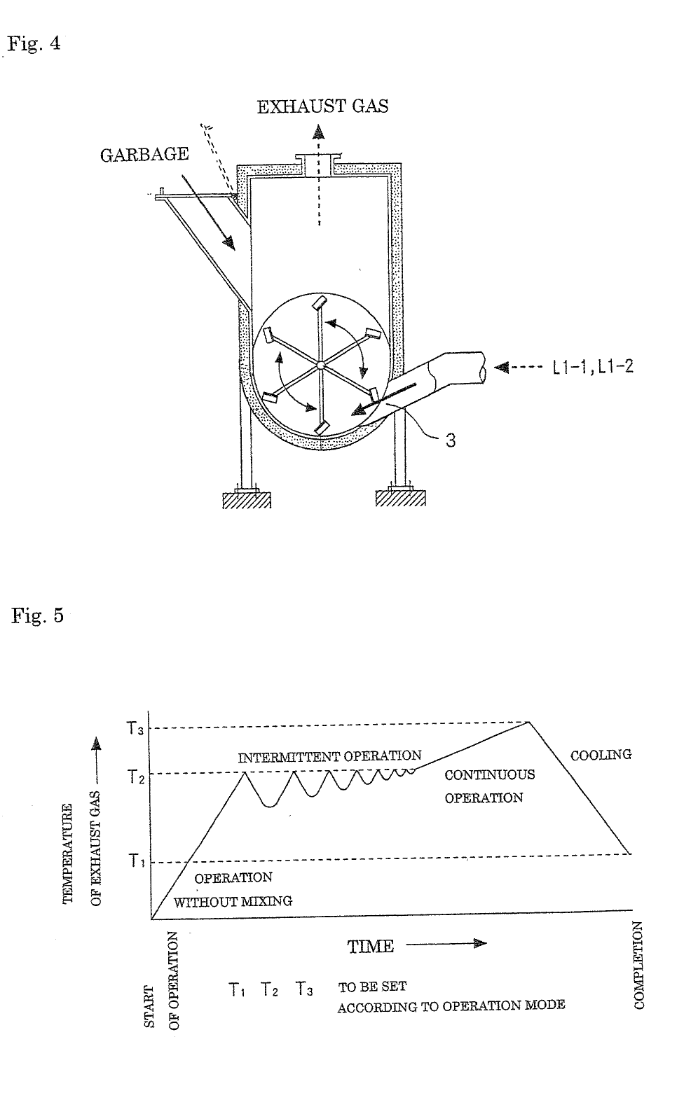

And, after the drying and the cooling process is completed like these, the dried garbage is easily taken out from the casing 1 and is recovered, by opening the air exit 11 placed on the bottom part of the casing 1. In this embodiment of the invention, however, though the embodiment is explained in the case that the two baffle plate 9 are provided and the upper space Z is divided into three portions, it goes without saying that the number of the baffle plate 9 is not limited to this number (two) but the number can be increased or decreased according to the size of the casing 1. And also, numbers of air entrance 3 and air exit 4 can be increased or decreased in case of need, for example, in the case of casing 1 with a small size, only one air entrance/exit hole can be provided at the center of the bottom part of the casing 1, and the air entrance/exit hole is divided into an air entrance portion in the right hand side direction and an air exit portion in the left hand side direction or vise versa to pass the air. Moreover, as showed in FIG. 4, if the air entrance 3 is connected with the bottom part of casing 1, with the air entrance 3 is directed to the lower oblique direction, a backward flow of water or as such accumulated in the bottom portion of the casing 1 can be prevented.

Next, as shown in FIG. 1, the temperature sensor T1 that constantly detects temperature of exhaust gas and sequencer S that controls the motor 7 in the side of the heating mixer M is provided in this exhaust gas line L2, so that the motor 7 is controlled sequentially according to the temperature of the exhaust gas, which temperature is detected by the temperature sensor T1.

On one hand, the blower 16 that takes in air in the atmosphere, the heater 17 of a heat-exchange type and the bypass line L3 that bypasses between an upstream side and a downstream side to the heater 17 are provided in the air supply line L1, and it is composed that the air that is taken into the blower 16 is heated in the heater 17 to generate high-temperature air for drying, or the air that is taken into the blower 16 is directly sent into the side of downstream of air supply line L1 from the bypass line L3 avoiding the heater 17. However, the flowmeter 18 is provided in the downstream side of the blower 16, it is composed that the motor 19 that actuates the blower 16 is controlled by the inverter mechanism 20 and the quantity of air taken into the blower 16 can be timely variably controlled. And also, it is composed that the bypass line L3 is divided from the air supply line L1 via the joint valve V3 and the air is flowed in a predetermined sequence.

On the other hand, deodorizing apparatus H is composed of the deodorizing furnace 21 that is a gas burner that uses LPG, LNG, etc. as fuel or a oil burner, and it is composed that odor ingredients contained in the exhaust gas are pyrolyzed at high temperature by using exhaust gas that flows through the exhaust gas line L2 as air for fuel as it is and the odor ingredients are deodorized. And also, in the downstream side of the deodorizing apparatus H, the preheater 22 and the heater 17 that is described above are connected in series, and as well as burning efficiency is increased by preheating exhaust gas by the preheater 22 before the exhaust gas is introduced into the deodorizing apparatus H by making good use of the heat of high-temperature exhaust gas after burning that is generated in the deodorizing apparatus H, the exhausted heat due to the preheating is recovered for use as a heat source of air for drying in the heater 17.

Moreover, in the upstream side of the exhaust gas line L2, the dust removing apparatus 23 such as a cyclone is provided, discharged solid ingredients (dry dust, etc.) that are exhausted with the exhaust gas from the heating mixer M are separated from the exhaust gas and are recovered.

Moreover, the circulating line L4 is provided between the exhaust gas line L2 that is located at the upstream side of the deodorizing apparatus H and the air supply line L1. And it is composed that a part of exhaust gas that is exhausted from the heating mixer M is made to join with high-temperature air for drying flowed through the air supply line L1 via this circulating line L4 and is made to circulate.

That is, it is composed that in this circulating line L4, the flow quantity controlling valve V4 and the blower 24 is provided, and the valve V4 and the blower 24 reduce the temperature of high-temperature air for drying that flows through the air supply line L1 to the optimum temperature by the exhaust gas that is made to join, at the same time a part of the exhaust gas is made to circulate through the air supply line L1 by putting back the part of the exhaust gas into the side of the air supply line L1 as well as the exhaust gas in the heating mixer M is made to compulsorily being drawn out by the blower 24. However, the flow amount of the flow amount controlling valve V4 is timely controlled by the temperature sensor T2 that is provided in the side of downstream of the flowing joint with the air supply line L1. And also, the motor 25 that actuates the blower 24 is also timely variably controlled by the inverter mechanism 26 according to a signal from the pressure sensor P1 that is provided in the side of heating mixer M.

Next, an example of operation and the operating method of the garbage processing machine of the present invention with these kind of composition is explained as follows.

At first, in the case of ordinal garbage, and main ingredients of which ingredients are difficult to be caked, for example, in the case of garbage, of which main ingredients include vegetable rubbish, meat rubbish, fish rubbish or as such, the garbage is heated and dried by supplying air for drying with an amount needed for drying from the air supply line L1 while the garbage is mixed by the mixing mechanism 2 after a fixed amount of garbage is thrown into the inside of the heating mixer M.

On one hand, air for drying, of which temperature is decreased by heating and drying garbage, becomes comparably low-temperature exhaust gas and is exhausted from inside of the heating mixer M into the exhaust gas line L2 and after the solid ingredients of the garbage is separated and recovered in the dust removing apparatus 23, a part of not-recovered ingredients join with air for drying that flows through the air supply line L1 as it is via the circulating line L4 by the blower 24, and again flows into the heating mixer M, and the remaining exhaust gas passes through the pre-heater 22 and is sent to the deodorizing apparatus H, and after the odor components of which is pyrolyzed by being burned here and is also deodorized and made harmless to become a clean gas, the clean gas is exhausted into the atmosphere after heat-recovered in the preheater 22 and the heater 17.

By these processes, as well as the garbage is effectively processed by heating and drying, air pollution and the deterioration of local environments are prevented at the same time since the odor ingredients that is generated at the time of drying is prevented from being exhausted into the atmosphere as it is.

Moreover, since a part of exhaust gas is made to circulate for use, in the case that the size of the heating mixer M is enlarged, that is, even in the case of increasing the dry-processed amount of garbage, a large amount of air for drying can be supplied into the heating mixer M without increasing the amount of air for drying and the amount of exhaust gas that is deodorized. And at the same time as this, since it becomes not needed to enlarge the size of the deodorizing apparatus H that deodorizes exhaust gas or the blower 16 that supplies air for drying, the heat loss of exhaust gas from the deodorizing apparatus H is decreased and the excellent heat efficiency is displayed as well as the cost increase can be suppressed.

By the way, in the case that the amount of air flow is increased in the heating mixer M by circulating a part of exhaust gas like this, the temperature in the heating mixer M is decreased and an efficient drying process can not be performed when the temperature of air for drying is the same as that conventionally used. That is, in the case of ordinal garbage, the optimum temperature for drying is ca. 200° C. When the temperature of the air for drying becomes far higher than this temperature (ca. 200° C.), there are cases that garbage becomes carbonized, and on the other hand when the temperature becomes far lower than this temperature (ca. 200° C.), there are cases that the period of processing becomes longer and the processing efficiency becomes remarkably deteriorated.

By this reason, air for drying needs to be heated up to, for example, ca. 400° C. in the heater 17 beforehand. By this pretreatment, an optimum temperature for drying is maintained even though low-temperature exhaust gas (ca. 80° C.) joins the pre-heated air for drying. However, enlargement of the size of the deodorizing furnace H proper is not especially needed in order to increase the temperature of air for drying, but the increase of the temperature of air for drying can be easily performed by improving heat recovery in the heater 17. Moreover, when this high-temperature air for drying is supplied into the heating mixer M, the inconvenience that garbage gathers only in the downstream side of the casing 1 and therefore the efficiency of drying process decreases can be prevented if the switching valves V1 and V2 are alternately changed every fixed period of time.

Next, in the case of the garbage that is apt to be caked, for example, in the case of the garbage of which main ingredients are rice or other grains etc., the mixing process does not start just after the garbage is thrown into the casing 1, but as shown in FIG. 2, the garbage is processed by a series of sequentially controlled operations including an operation without mixing for a fixed period of time, an intermittent mixing operation and a continuous operation, resulting in the prevention of the garbage from being caked in the heating mixer M.

That is, in the case of a high viscosity garbage that has rice or grains etc. as main ingredients, when the mixing process starts before the garbage dries to a certain extent, the garbage is caked by the mixing process and the caked garbage sticks to the mixing impellers 8 of the mixing mechanism 2 or the inner wall of the casing 1, resulting in the inconvenience that the difficulty of exhausting the garbage decreases the volume of the inside of the heating mixer M as well as effective drying process can not be performed.

Therefore, as shown in FIG. 5 in the case of the garbage that is apt to be caked, at first, a dry processing is performed by only dried air without actuating the mixing mechanism 4 for a fixed period of time since the garbage is started to be thrown into the casing 1. However, this dried state is assumed by constantly detecting the temperature of exhaust gas with the temperature sensor T1. That is, since the temperature of the garbage is low and the garbage contains a large content of water at the beginning step of drying process, inside of the casing 1 has the condition that the temperature of exhaust gas is also low. But, as the drying process proceeds and the content of water in the garbage decreases, the temperature of exhaust gas gradually increases and then the drying state of the garbage is generally presumed by detecting temperature by the temperature sensor T1. Therefore, though the temperature of exhaust gas is also low just after the start of this operation without mixing, the temperature of exhaust gas gradually increases as time passes and drying process proceeds. And when the temperature of the exhaust gas reaches a predetermined temperature T₂, the intermittent operation stops after the mixing mechanism 2 is made to rotate for a fixed period of time, for example, for several rotations. Then, since the garbage of the inside, which garbage does not directly contact with air for drying, is exposed, and the water contained in the garbage evaporate at a stretch and also the temperature increases again after the temperature of exhaust gas decreases at first, if the temperature of exhaust gas reaches the temperature T₂ again, the intermittent operation, in which the mixing mechanism 2 is made to rotate for several rotations and stops, is performed.

Next, when the distance between intermittent operations like this is gradually shortened with the increase of the temperature of the garbage, it is judged that the drying process of the whole garbage proceeds to the degree, in which the state of being caked is avoided. And thereafter, the operation of the mixing mechanism 2 is changed to the normal operation, the temperature reaches a predetermined temperature T₃, that is, when the temperature at which it is admitted that the drying is complete, the drying process is completed by cooling the dried garbage by replacing air for drying with air for cooling with the valve V3 of the air supply line L1 to the predetermined temperature T₁, for example, to the degree in which an operator etc. can handle the garbage with his/her bare hands.

Therefore, it is possible that even the garbage that is apt to be caked can be effectively dry-processed, with the garbage not being caked, by proceeding a series of processes in turn including an operation without mixing, an intermittent mixing operation, a continuous operation and a cooling according to the temperature of exhaust gas like these.

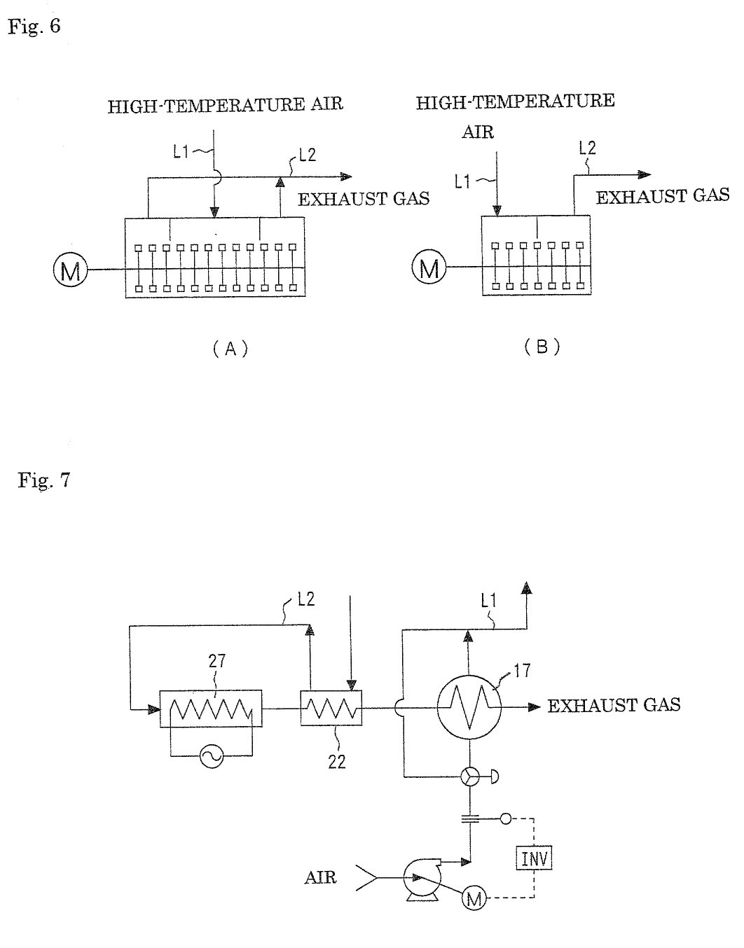

However, as the other embodiment of the present invention, in the case of the intermediated-sized heating mixer 1 with less inhomogeneous drying and cooling, as shown in FIG. 6(A), the air supply line L1 is connected with only the center part of the casing 1, discharging the air from the both ends. In this case, it becomes possible to further simplify the structure, and as shown in FIG. 6 (B), in the case of the further smaller heating mixer 1, as the effect of the dried garbage that inhomogeneously gathers only in the upper portion of the casing 1 is small, dried air and cooled air can be flowed from one direction.

And, as shown in FIG. 7, it is also possible to decompose the odor ingredients by the heat and catalytic effects, using the electric heater 27 of which a catalyst like platinum etc. for decomposing odor ingredients is filled in, in place of the deodorizing furnace 21 that constitutes the deodorizing apparatus H. Moreover, though the heat efficiency decreases a little in case that a catalyst is not attached on the electric heater 27, the cost can be decreased instead. And also, the garbage like vegetable rubbish, fish rubbish etc., which garbage have no risk of being caked, the optimum operation can be easily performed if a switch for mode change is provided at need in order to start continuous operation from the beginning.

What is claimed is:

1. A garbage processing machine, wherein both an air supply line that supplies high-temperature air for drying and air for cooling, and an exhaust gas line that exhausts the air, are connected to a heating mixer that dry-processes garbage with mixing, and also wherein the garbage processing machine is comprising:
a deodorizing apparatus that is provided in an exhausted gas line and deodorizes exhausted gas at high temperature; and
a heater, which is provided in the air supply line and heats air by exhausted heat that is exhausted from the deodorizing apparatus.

2. A garbage processing machine according to claim 1, wherein a circulating line that is made to circulate a part of exhaust gas into the air supply line is connected to the exhaust gas line.

3. A garbage processing machine according to claim 1, wherein a preheater that preheats exhaust gas before the exhaust gas is introduced into a deodorizing apparatus is provided in downstream side of the deodorizing apparatus.

4. A garbage processing apparatus according to claim 1, wherein a dust removing apparatus is provided in the upstream side of the exhaust gas line.

5. A garbage processing apparatus according to claim 1, wherein the air supply line is divided into a plural number of air supply lines and the divided air supply lines are connected to the heating mixer.

6. A garbage processing apparatus according to claim 1, wherein the exhaust gas line is divided into a plural number of exhaust gas lines and the divided exhaust gas lines are connected to the heating mixer.

7. An operating method of garbage processing machine, wherein
in a garbage processing machine, wherein both an air supply line that supplies high-temperature air for drying and air for cooling, and an exhaust gas line that exhausts the air, are connected to a heating mixer that dry-processes garbage with mixing, and also wherein the garbage processing machine is comprising:
a deodorizing apparatus that is provided in an exhausted gas line and deodorizes exhausted gas at high temperature; and
a heater, which is provided in the air supply line and heats air by exhausted heat that is exhausted from the deodorizing apparatus,
the exhaust gas temperature is constantly watched since the heating mixer starts operation of the heating mixer, only air for drying is supplied as it is from air supply line without mixing garbage until the temperature of exhaust gas reaches predetermined temperature,
an operation that mixes garbage by actuating the heating mixer only when temperature of the exhaust gas reach a predetermined temperature is intermittently performed,
the heating mixer is made to actuate continuous mixing when the distance between actuations becomes lower than a predetermined time, and afterwards,
a cooling process is made to start by passing cooled air instead of air for drying when a temperature of the exhaust gas temperature reach a predetermined maximum temperature.

8. A heating mixer, wherein
in the heating mixer for dry-processing of garbage, it is composed that as well as a rotating axis is axially supported, which axis is the same as that of the bottom of a casing, in the casing with a shape like a generally rectangular shape or as such, a plural number of mixing impellers are radially provided over the rotating axis and along the axis, and also as well as air entrances are formed at the bottom part of the casing with a shape like a generally rectangular shape or as such, air exits are formed at the upper part of the casing.

9. A heating mixer according to claim 8, wherein a pair of air entrances and a pair of exits for exhaust gas are provided.

10. A heating mixer according to claim 8, wherein baffle plates that divide the upper space of the casing along the longitudinal direction of the casing are provided in the upper space in the casing with a shape like a generally rectangular shape or as such.

11. A heating mixer according to claim 10, wherein the air entrances and the exits for exhaust gas are provided in the corners of the casing, of which corners are separated by the baffle plates.

12. A heating mixer according to claim 8, wherein an air supply line is connected in lower oblique direction to the air entrance.

13. A heating mixer according to claim 8, wherein a mixing tip, which is inclined in the rotating direction and also in the longitudinal direction of the rotating axis, is provided at the edge of each of the mixing impellers.
